(19) United States
(12) Patent Application Publication
(10) Pub. No.: US 2025/0306934 A1
(43) Pub. Date: Oct. 2, 2025

(54) ACCELERATOR CONTEXT SWITCHING

(71) Applicant: Meta Platforms Technologies, LLC, Menlo Park, CA (US)

(72) Inventors: Jun Wang, San Jose, CA (US); Kyong Ho Lee, Los Altos, CA (US); Xu Chen, San Jose, CA (US); Simon James Hollis, Redmond, WA (US)

(21) Appl. No.: 18/616,973

(22) Filed: Mar. 26, 2024

(51) Int. Cl. G06F 9/30

(52) U.S. Cl. CPC G06F 9/30094; G06F 8/41; G06N 20/00

(57) ABSTRACT

The disclosed computer-implemented method may include recognizing a last instruction of a layer from a subset of a plurality of layers of a first machine learning model during its execution. The method may also include identifying a request for executing a second machine learning model and performing a context switch to the second machine learning model after executing the last instruction of the layer. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. 1A-B are diagrams of inference latency for an accelerator.

FIG. 2 is a flow diagram of an exemplary method for accelerator context switching.

FIG. 3 is a block diagram of an exemplary system for accelerator context switching.

FIG. 4 is a block diagram of an exemplary network for accelerator context switching.

FIGS. 5A-B are block diagrams of exemplary graphs and subgraphs.

FIG. 6 is a block diagram of an exemplary instruction flow for accelerator context switching.

FIG. 7 is a timeline diagram of exemplary accelerator context switching.

FIG. 8 is an illustration of exemplary augmented-reality glasses that may be used in connection with embodiments of this disclosure.

FIG. 9 is an illustration of an exemplary virtual-reality headset that may be used in connection with embodiments of this disclosure.

FIG. 10 an illustration of an exemplary system that incorporates an eye-tracking subsystem capable of tracking a user's eye(s).

FIG. 11 is a more detailed illustration of various aspects of the eye-tracking subsystem illustrated in FIG. 10.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Machine learning (ML) and other artificial intelligence (AI) schemes allow predictive inferences and other tasks to be performed based on, for example, real-world data in real-time or near real-time. Accelerators may be processors configured for ML-type computational workloads and are often used in servers, in order to meet computational resource requirements for running ML models. However, as different types of computing devices have accelerators or otherwise are expected to perform ML computations, additional efficiencies for ML requests may be needed as these computing devices may have more restricted computational resources.

For example, a computing device may receive multiple ML requests having different priorities. Although a conventional processor may use context switching between processes/threads to execute multiple processes, such conventional context switching may not be applied to ML requests due to, for example, memory requirements for a given ML request.

The present disclosure is generally directed to accelerator context switching. As will be explained in greater detail below, embodiments of the present disclosure may recognize a last instruction of a last layer of a subset of layers for a first ML model, and if a context switch request to a second ML model is pending, perform a context switch to the second ML model after executing the last instruction. The systems and methods described herein may improve the functioning of a computer itself by more efficiently managing computing resources to reduce a latency of running multiple ML models, particularly for higher priority ML requests, and may further improve memory management and usage for multiple ML models. The systems and methods provided herein may further improve the technical field of machine learning by allowing context switching using processors including accelerator or ML hardware.

Features from any of the embodiments described herein may be used in combination with one another in accordance with the general principles described herein. These and other embodiments, features, and advantages will be more fully understood upon reading the following detailed description in conjunction with the accompanying drawings and claims.

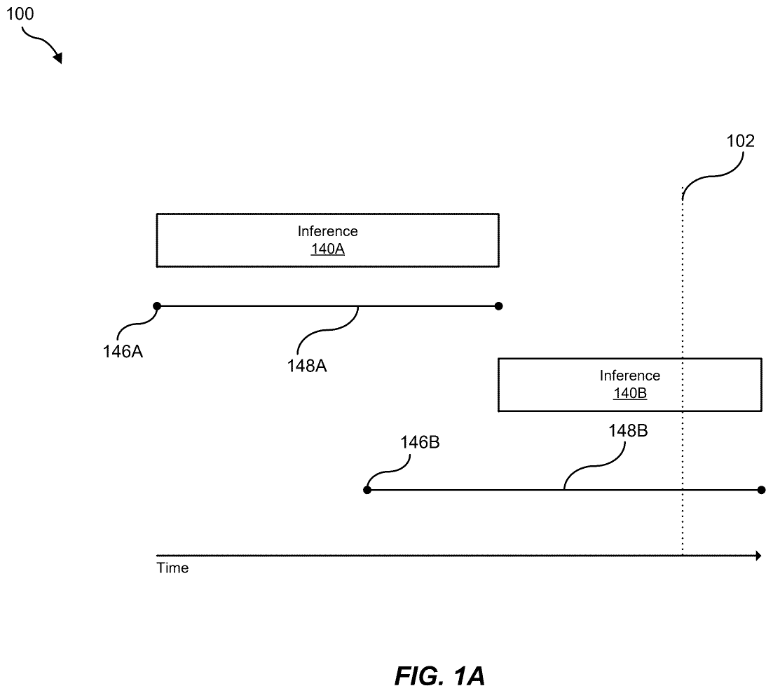

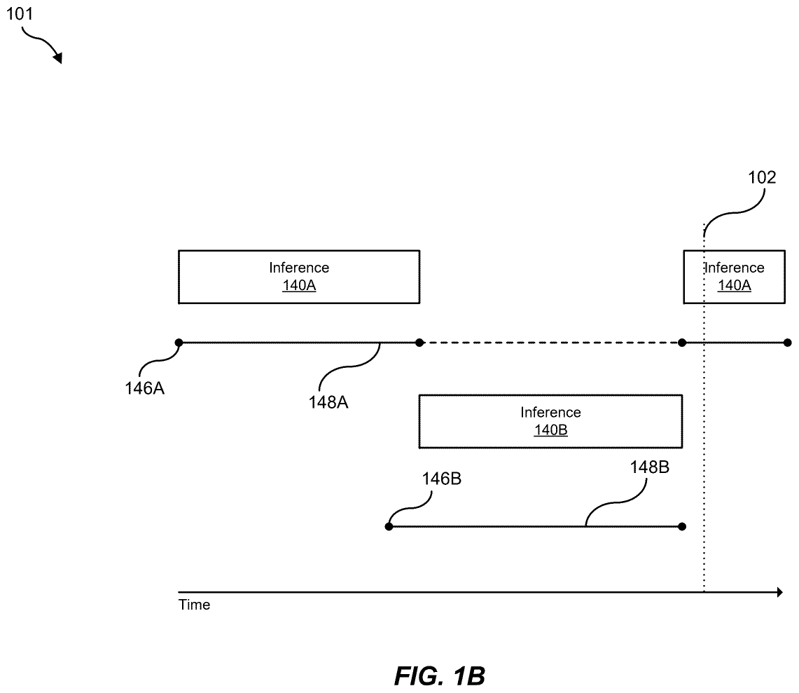

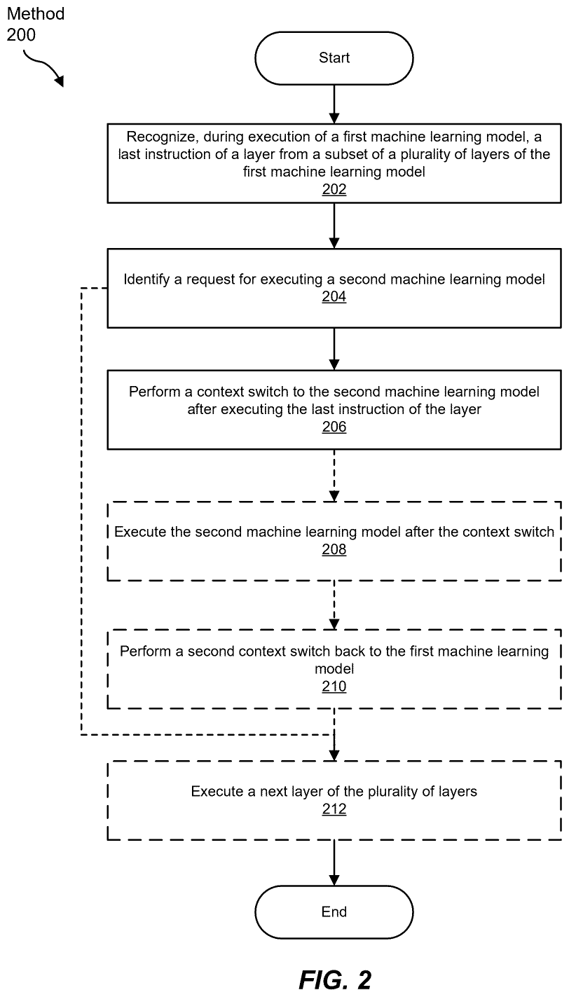

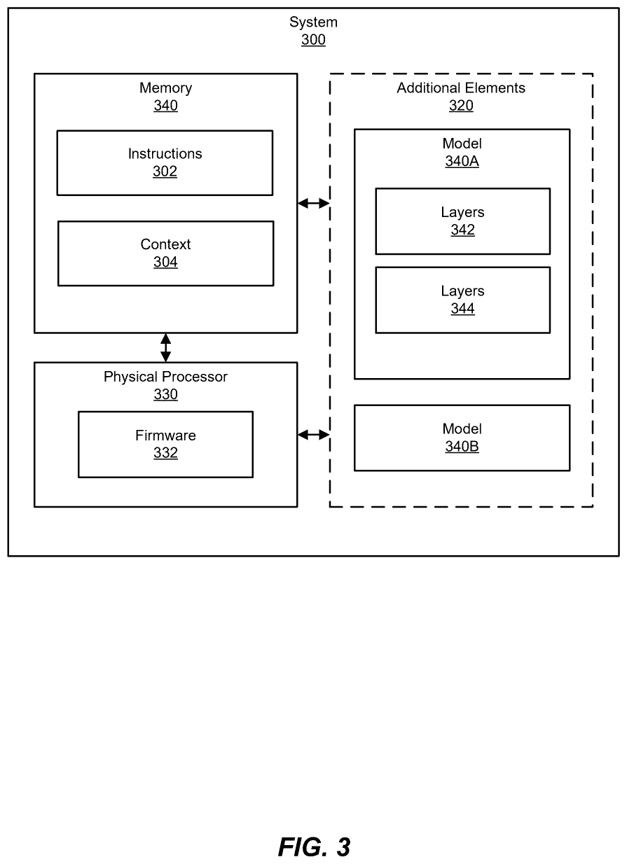

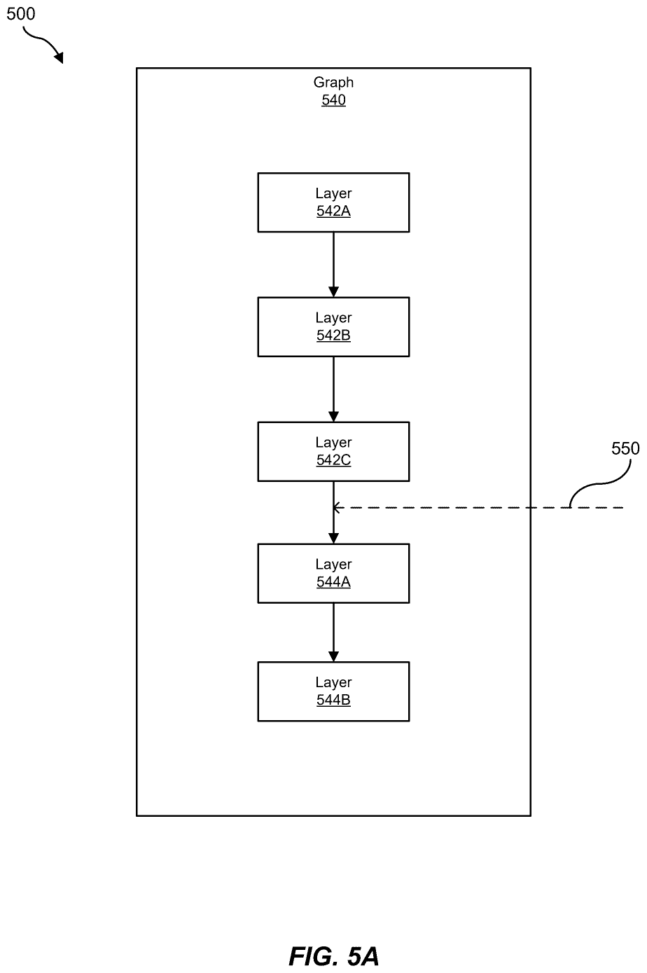

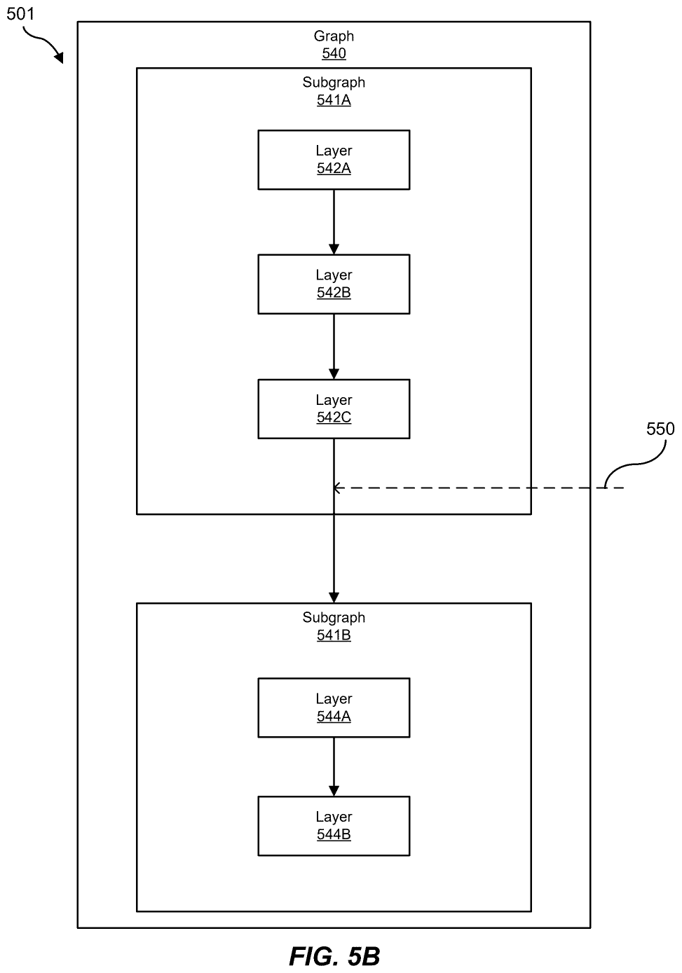

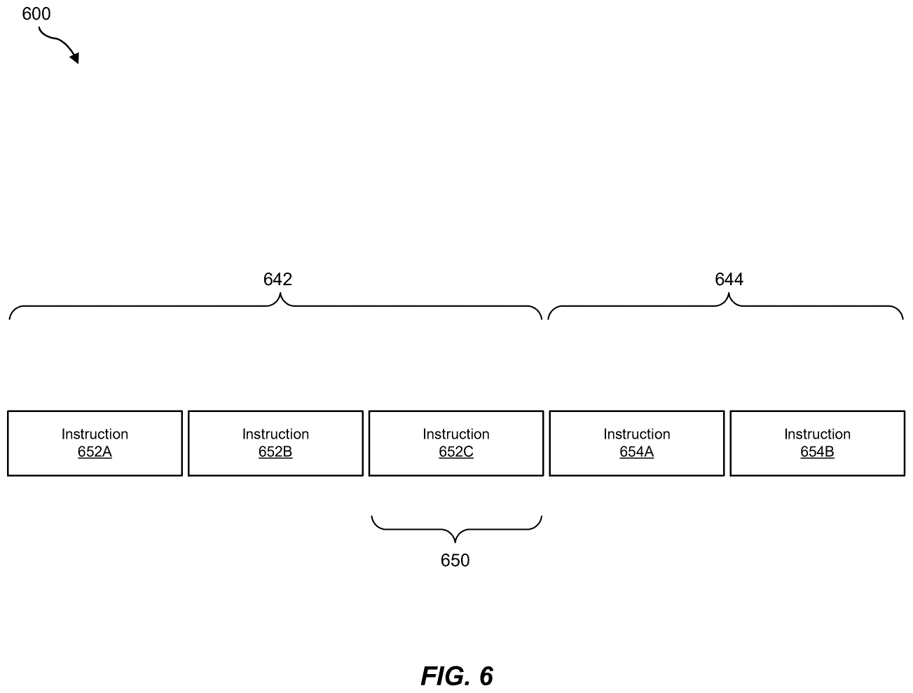

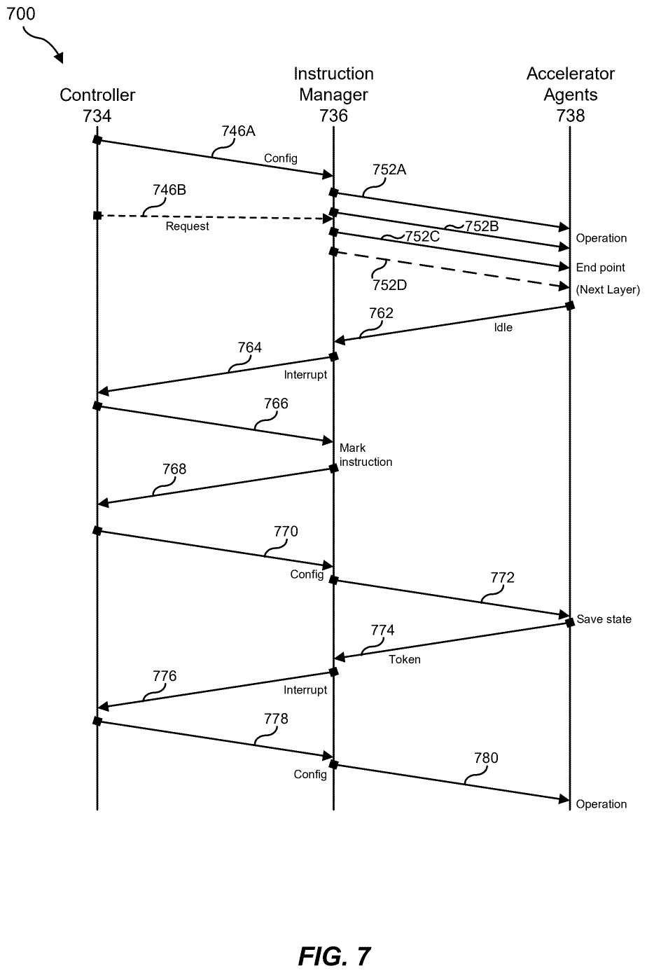

The following will provide, with reference to FIGS. 1-9, detailed descriptions of accelerator context switching. Detailed descriptions of inference latency will be provided in connection with FIGS. 1A-1B. Detailed descriptions of example methods or processes of accelerator context switching will be provided in connection with FIGS. 2 and 7. Detailed descriptions of context switch points will be provided in connection with FIGS. 5A-5B and 6. In addition, detailed descriptions of example systems for accelerator context switching will be provided in connection with FIGS. 3 and 4-9.

FIGS. 1A-1B illustrate simplified examples of a timeline 100 and a timeline 101, respectively. In FIG. 1A, an inference 140A may be enqueued at point 146A and exhibit an inference latency 148A. In addition, an inference 140B may be enqueued at point 146B and exhibit an inference latency 148B. As used herein, an “inference” may refer to running live data or other input data into a trained machine learning model or other artificial intelligence program to make a prediction or otherwise solve a task that the model may be trained for. Examples of inferences may include, without limitation, executing code/instructions corresponding to layers of a machine learning model (e.g., for neural network-based models such as graph neural networks). As used herein, an “inference latency” may refer to a latency (e.g., a time delay) from when an inference is requested to when the inference is complete or otherwise concluded (e.g., providing a suitable output). As described herein, inference latency may include a time for computationally processing the inference as well as related overhead.

In FIG. 1A, for a computing system capable of processing multiple machine learning models (e.g., performing inferences using different models), inference 140A may be requested and/or enqueued at point 146A and inference 140A may continue generally uninterrupted until completion, such that inference latency 148A for inference 140A is generally similar (e.g., without having significant other delay factors) to the overhead for performing inference 140A. As illustrated in FIG. 1A, inference 140B may be requested and/or enqueued at point 146B during inference 140A. Accordingly, inference 140B may wait until inference 140A is complete such that inference latency 148B is greater than the overhead for performing inference 140B, namely that it may include time waiting on inference 140A to complete before inference 140B can begin.

However, in some examples, inference 140B may be a high priority inference, for example having an inference deadline 102, such that inference 140B should be completed by inference deadline 102. In this sense, inference 140B may be higher priority than inference 140A, for instance inference 140B may be a high priority inference needing an output by inference deadline 102 whereas inference 140A may be a low priority inference having no inference deadline or otherwise having an inference deadline later than inference deadline 102 of inference 140B.

As illustrated in FIG. 1A, waiting for inference 140A to complete before beginning inference 140B may cause inference 140B to undesirably miss inference deadline 102. Alternatively, even if inference 140B did not have inference deadline 102, inference latency 148B may be prohibitively large (e.g., larger than inference latency 148A and/or otherwise undesirably large). Accordingly, it may be desirable to accommodate a higher priority inference such as inference 140B (e.g., so as not to miss an inference deadline, such as inference deadline 102). FIG. 1B illustrates timeline 101 in which context switching may be used. As used herein, “context switching” may refer to storing or otherwise saving a state of a process or thread to be later restored for resuming execution of the process/thread, which may further allow a different process/thread to execute. For example, a processor may save a state of a first thread, load a second thread, and after completing execution of the second thread, restore the first thread to resume execution of the first thread, thus allowing multiple processes/threads to share computing resources. Further, as used herein, “process” may refer to an instance of a computer program (e.g., running/executing a machine learning model) executed via one or more threads. Further, as used herein, “thread” may refer to a sequence of executed instructions of a computer program, which may be part of a process. In some implementations, a thread may correspond to a virtualized processor such as a virtual core of a processor having one or more cores that may execute portions of a process/program.

As illustrated in FIG. 1B, shortly after inference 140B is requested at point 146B, a context switch from inference 140A to inference 140B allows inference 140B to execute before inference 140A completes. Thus, inference latency 148B is reduced (as compared to FIG. 1A) which may also allow inference 140B to meet inference deadline 102. Once inference 140B is complete, a restoring inference 140A (e.g., similar to a context switch back to inference 140A) allows inference 140A to continue execution. Although inference latency 148A for inference 140A may increase, such an increase may be a desirable tradeoff in order to reduce inference latency 148B of inference 140B having higher priority and further to meet inference deadline 102. However, context switching between inferences may include additional computing resources (e.g., memory considerations for saving states) not illustrated in FIG. 1B. As will be explained further below, saving a state may require enough memory for saving a state of an inference, which may include, for example, tensors, weights, etc., to an external memory (e.g., a memory beyond internal memory devices and/or registers in a processor). Accordingly, context switching between inferences may require additional resources and overhead beyond context switching between processes.

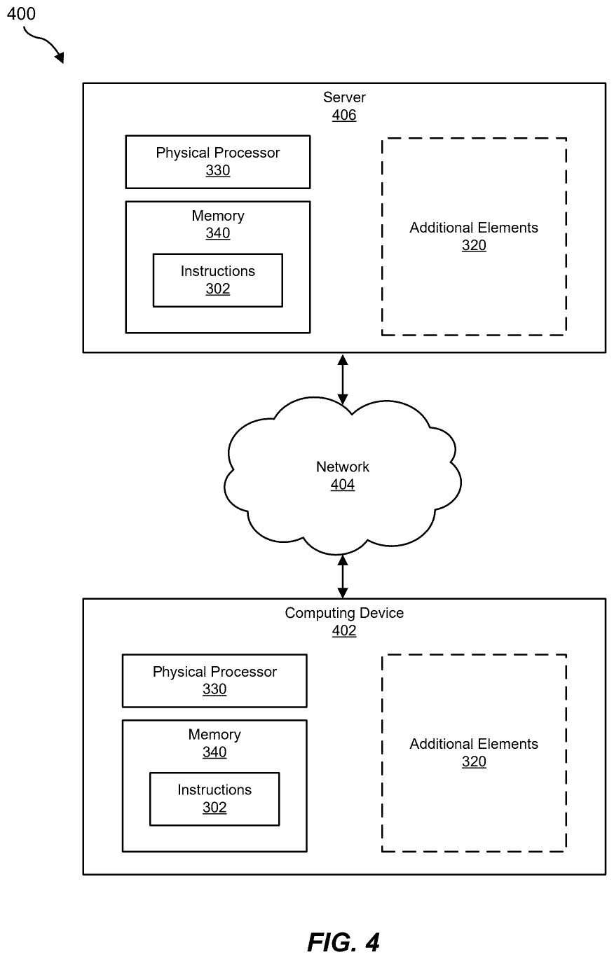

FIG. 2 is a flow diagram of an exemplary computer-implemented method 200 for accelerator context switching. The steps shown in FIG. 2 may be performed by any suitable computer-executable code and/or computing system, including the system(s) illustrated in FIGS. 3, 4, and/or 8-10. In one example, each of the steps shown in FIG. 2 may represent an algorithm whose structure includes and/or is represented by multiple sub-steps, examples of which will be provided in greater detail below.

As illustrated in FIG. 2, at step 202 one or more of the systems described herein may recognize, during execution of a first machine learning model, a last instruction of a layer from a subset of a plurality of layers of the first machine learning model.

In some embodiments, the term “model” may refer to a machine learning program that may provide an inference or otherwise perform a task from an input dataset, and may be trained to do so from a training dataset. Examples of models include, without limitation, logistic regression, linear regression, support vector machines, naive Bayes, decision trees, nearest neighbors, random forest, boosting, clustering, neural networks, etc. For example, a neural network may include multiple node layers, such as an input layer, one or more hidden layers, and an output layer, each having nodes. Each node may be associated with a weight and/or threshold may connect to another node (e.g., of another layer) for sending data to the next layer (such as after processing data received from a previous layer). In some examples, intermediary outputs between layers may be represented by weights, thresholds, and/or tensors (e.g., mathematical objects for describing multilinear relationships between objects such as scalars, vectors, matrices and may be represented by higher-dimensional matrices for mapping between different objects).

Various systems described herein may perform step 202. FIG. 3 is a block diagram of an example system 300 for accelerator context switching. As illustrated in this figure, example system 300 may include one or more instructions 302 for performing one or more tasks. Although illustrated as a separate element, one or more of instructions 302 in FIG. 3 may represent portions of a single program or application and/or other element described herein.

In certain embodiments, one or more of instructions 302 in FIG. 3 may represent one or more software applications or programs that, when executed by a computing device, may cause the computing device to perform one or more tasks. For example, and as will be described in greater detail below, one or more of instructions 302 may represent instructions stored and configured to run on one or more computing devices, such as the devices illustrated in FIG. 4 (e.g., computing device 402 and/or server 406) and/or 8-10. One or more of instructions 302 in FIG. 3 may also represent all or portions of one or more special-purpose computers configured to perform one or more tasks.

As illustrated in FIG. 3, example system 300 may also include one or more memory devices, such as memory 340. Memory 340 generally represents any type or form of volatile or non-volatile storage device or medium capable of storing data and/or computer-readable instructions. In one example, memory 340 may store, load, and/or maintain one or more of instructions 302. Examples of memory 340 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory. Memory 340 may include a context 304 corresponding to a state of an inference that may be stored for a context switch to restore the inference, as will be described further below.

As illustrated in FIG. 3, example system 300 may also include one or more physical processors, such as physical processor 330. Physical processor 330 generally represents any type or form of hardware-implemented processing unit capable of interpreting and/or executing computer-readable instructions. In one example, physical processor 330 may access and/or modify one or more of instructions 302 stored in memory 340. Additionally or alternatively, physical processor 330 may execute one or more of instructions 302 to facilitate accelerator context switching. Examples of physical processor 330 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor. Processor 330 may further include, for example, a firmware 332 representing control logic for processor 330 (e.g., for managing an instruction pipeline and/or other aspects of processing tasks) as well as controllers and other circuits for performing processing tasks.

As illustrated in FIG. 3, example system 300 may also include one or more additional elements 320, such as a model 340A including layers 342 and layers 344, and/or a model 340B. Model 340A and model 340B may represent machine learning models, as will be explained further below. Layers 342 and layers 344 may represent subsets of the layers of model 340A, as will also be further explained below. Model 340A and/or model 340B may be stored on a local storage device, such as memory 340, or may be accessed remotely.

Example system 300 in FIG. 3 may be implemented in a variety of ways. For example, all or a portion of example system 300 may represent portions of example network environment 400 in FIG. 4.

FIG. 4 illustrates an exemplary network environment 400 implementing aspects of the present disclosure. The network environment 400 includes computing device 402, a network 404, and server 406. Computing device 402 may be a client device or user device, such as an artificial reality system a desktop computer, laptop computer, tablet device, smartphone, or other computing device. Computing device 402 may include a physical processor 330, which may be one or more processors, memory 340, which may store data such as one or more of additional elements 320, and other components as needed. In some implementations, computing device 402 may represent an augmented reality device such that a display overlays images onto a user's view of his or her local environment. For example, the display may include a transparent medium that allows light from the user's environment to pass through such that the user may see the environment. The display may then draw on the transparent medium to overlay information. Alternatively, the display may project images onto the transparent medium and/or onto the user's eyes. Computing device 402 may also include a speaker for sound output.

Server 406 may represent or include one or more servers capable of hosting machine learning models. Server 406 may provide inferences for and/or in conjunction with computing device 402. Server 406 may include a physical processor 330, which may include one or more processors, memory 340, which may store instructions 302, and one or more of additional elements 320.

Computing device 402 may be communicatively coupled to server 406 through network 404. Network 404 may represent any type or form of communication network, such as the Internet, and may comprise one or more physical connections, such as LAN, and/or wireless connections, such as WAN.

The systems described herein may perform step 202 in a variety of ways. In one example, processor 330 and/or a controller thereof, may recognize a last instruction (e.g., an instruction of instructions 302) of a layer (e.g., from a last layer of layers 342) from a subset of a plurality of layers (e.g., layers 342) of a first machine learning model (e.g., model 340A) during execution of the first machine learning model.

In some examples, the plurality of layers may correspond to a graph, such as a collection of neural network layers as will be described with respect to FIGS. 5A-5B. FIG. 5A illustrates a model 500 including a graph 540 corresponding to model 340A. When a hardware accelerator (e.g., processor 330) performs an inference using a model (e.g., model 340A), the inference may proceed with performing instructions (e.g., instructions 302) associated with graph 540, and more specifically the instructions corresponding to a layer 542A, a layer 542B, a layer 542C, a layer 544A, and a layer 544B, which may each correspond to layers of a neural network. Graph 540 illustrates a simplified example, although in other examples, other layer arrangements (e.g., connections/outputs between various other layers) may be used.

As described herein, context switching between inferences or workloads may require significant overhead, such as memory requirements for saving a state (e.g., context 304). For instance, saving the state may include saving intermediate values, weights, tensors, etc. In some implementations, certain points (e.g., instructions) during execution of graph 540 may have smaller states for saving than at other points such that selecting such points may reduce memory requirements for saving the state to reduce an overhead for context switching. Analyzing graph 540, for example via a compiler, may identify points in which a memory usage of a subgrouping of layers (e.g., a subgraph) may satisfy a memory usage threshold (e.g., the context size being less than a threshold memory size which may be dynamically determined by monitoring context sizes and/or predetermined or corresponds to a local minimum memory usage such that the context size at the point may be less than a context size within a window of instructions before and/or after the point). In some examples, these points may correspond to graph analysis, such as min-cut points of a graph. FIG. 5A illustrates a point 550 selected as described above. Based on point 550, graph 540 may be split (e.g., by grouping layers) into subgraphs, such as a subgraph 541A (corresponding to layers 342) and subgraph 541B (corresponding to layers 344) illustrated in FIG. 5B.

FIG. 5B illustrates a model 501 (corresponding to model 500) having subset of the layers of graph 540 forming the subgraphs, namely layer 542A, layer 542B, and layer 542C forming subgraph 541A and layer 544A and layer 544B forming subgraph 541B. In some examples, point 550 may correspond to a min-cut point such that subgraph 541A and subgraph 541B correspond to subgraphs formed from dividing graph 540 based on the min-cut point. During execution, subgraph 541A and subgraph 541B may execute layers in a same order/sequence as graph 540 not being divided. However, as will be described further below, if a context switch happens at point 550 (e.g., after completing subgraph 541A), restoring graph 540 may include returning to point 550 to continue execution with subgraph 541B. Moreover, although FIGS. 5A-5B illustrate a single point (e.g., point 550) for dividing graph 540, in other examples, additional points may further divide graph 540 into additional subgraphs.

Point 550 may correspond to a last instruction of a layer, as will be described with respect to FIG. 6, which may correspond to a point when an output of a layer (e.g., tensor) and/or subgraph is calculated, although in other examples point 550 may correspond to other points of execution within a layer (e.g., a point corresponding to a local minimum for context size and/or memory usage). FIG. 6 illustrates an instruction sequence 600 (corresponding to instructions 302) representing a portion of an instruction sequence for executing graph 540.

FIG. 6 illustrates instructions 642 (corresponding to instructions for layer 542C) and instructions 644 (corresponding to instructions for layer 544A). Instructions 642 may include an instructions 652A, an instructions 652B, and an instruction 652C and instructions 644 may include an instruction 654A and an instruction 654B. As illustrated in FIG. 6, instruction 652C corresponds to a last instruction 650 (corresponding to point 550) as the last instruction of the last layer of the subgroup.

In some examples, last instruction 650 may include a last instruction flag to indicate the end of the subgroup, which may further indicate an appropriate context-switching point. For example, the last instruction flag may be a bit flag (e.g., a single bit such as “1” representing the last instruction and “0” otherwise) as part of an instruction header which may be determined based on an instruction set architecture (ISA). Further, based on the graph analysis described above, in some implementations a compiler may set the last instructions flag in the appropriate header for the last instruction (e.g., in a header of last instruction 650). The last instruction flag may be read or otherwise identified by a processor and/or accelerator (e.g., processor 330) when loading (e.g., fetching and/or decoding) the instruction.

Moreover, recognizing the last instruction may correspond to a beginning or otherwise early stage of an instruction pipeline/workflow. For instance, as will be described further below, the following steps of method 200 may proceed while the last instruction is being executed.

Turning back to FIG. 2, at step 204 one or more of the systems described herein may identify a request for executing a second machine learning model. For example, processor 330 and/or a controller thereof may identify a request for executing model 340B.

The systems described herein may perform step 204 in a variety of ways. In one example, processor 330 may identify the request for model 340B as being a higher priority than a priority of model 340A. For instance, the request may indicate having an inference deadline that may be more urgent than an inference deadline for model 340A, or model 340A may not have an inference deadline. In other examples, model 340B may be designated as having a higher priority than model 340A in addition to and/or in alternative to inference deadlines.

Further, identifying the request for executing the second machine learning model may include selecting a highest priority request from a plurality of outstanding requests from machine learning models. The highest priority may be determined from one or more factors. For example, processor 330 may identify multiple outstanding requests and select the most urgent request (e.g., based on urgency of inference deadline and/or priority of corresponding model). Moreover, at each context switching point (e.g., including context switching to restore a prior state), processor 330 may select a highest priority of outstanding requests and/or saved states. In other words, the highest priority request may correspond to a previously saved state, such as continuing model 340A by restoring a state from layers 342 to continue onto layers 344.

In addition, priority may be based on QoS-based identification, such as each inference/workload being associated with a particular priority. In some examples, each inference/workload may correspond to different types of workloads (e.g., model 340A and/or model 340B may correspond to similar or different types of models/workloads). Non-limiting examples of workloads may include computer vision inferences (e.g., hand tracking, eye tracking, image segmentation, object classification, object detection, optical character recognitions (OCR), codec avatars), computational graphics and/or image and video processing (e.g., image denoising, video denoising, image super-resolution, video super-resolution, auto white balance (AWB), auto exposure (AE), auto focus (AF)), audio processing (e.g., wake word recognition, automatic speech recognition (ASR), speech synthesis), language processing (e.g., language models such as large language models (LLM)), other models (e.g., multi-modal models), human computer interaction processing, etc. For example, different types of workloads may be associated with different priorities. In some examples, priorities may correspond to urgency/deadlines as described herein, which may further correspond to user experience. For instance, workloads corresponding to user inputs (in which a user may expect an output or response) may be considered higher priority than workloads corresponding to passive or continuous tasks.

Further, in some examples, processor 330 may dynamically determine priority, such as dynamically reprioritizing inferences/workloads, overriding priorities, changing priorities of workloads, updating urgencies, etc. For example, certain tasks/inferences may raise priorities of other related workloads, and/or idleness of certain tasks/inference may lower priorities of other related workloads.

Moreover, in some examples, if no requests for context switch are available (e.g., no outstanding requests and/or no requests having a higher priority than the currently running model), method 200 may instead continue to step 212, as will be described further below. In some examples, continuing to step 212 may incur little to no overhead (e.g., may not significantly disrupt a processing workflow). For example, in response to seeing no suitable requests for context switching, processor 330 may continue with a next layer of the current model (e.g., layers 344 of model 340A). In other words, processor 330 may determine whether there is a request for executing the second machine learning model (e.g., corresponding to a context switch) before the last instruction completes execution, such that if there is no context switch, processor 330 may proceed with the next instruction (e.g., before the last instruction completes execution) without significantly deviating from the normal instruction execution pipeline/workflow.

At step 206 (e.g., after identifying a suitable request), one or more of the systems described herein may perform a context switch to the second machine learning model after executing the last instruction of the layer. For example, processor 330 and/or a controller thereof may perform the context switch to model 340B.

The systems described herein may perform step 206 in a variety of ways. In one example, the context switch includes saving a memory state of the subset of the plurality of layers (e.g., layers 342), for instance processor 330 may interface with appropriate memory controllers to save context 304. In some examples, context 304 may be stored locally on chip (e.g., registers and/or memory devices on/near processor 330) while executing layers 342, which may then be saved to a memory such as memory 340. Further, as will be described below, initiating the context switch may occur before the last instruction completes such that initiating the context switch may pause further instruction execution until, for instance, after the context switch completes.

Continuing method 200, at step 208 one or more of the systems described herein may execute the second machine learning model after the context switch. For example, processor 330 may execute instructions 302 corresponding to model 340B. Executing the second machine learning model may include, for example, reading values (e.g., weights, tensors, inputs, etc. which may be stored in memory 340) to establish a new current context. In addition, in some examples, executing the second machine learning model may correspond to executing a portion of the inference. For instance, processor 330 may recognize a last instruction (e.g., similar to step 202) for the current inference.

At step 210 one or more of the systems described herein may perform a second context switch back to the first machine learning model. For example, processor 330 may perform a context switch to restore model 340A (e.g., for executing layers 344). As described herein, performing the context switch may including initiating the context switch (e.g., before a last instruction completes), and saving the current context to memory (e.g., memory 340) if needed (e.g., if the current inference/workload is not completed or context restoring is otherwise needed).

The systems described herein may perform step 210 in a variety of ways. In some examples, processor 330 may recognize, for the current inference, a last instruction similar to described above with respect to step 202. In one example, as described above, processor 330 may not identify any other pending requests and/or any requests having higher priority than model 340A. In other examples, processor 330 may instead context switch to a highest priority request. For instance, processor 330 may perform various iterations and/or partial iterations of method 200 to perform context switches between workloads as needed, until reaching a point where processor 330 identifies model 340A as the highest priority request.

Continuing to step 212, one or more of the systems described herein may execute a next layer of the plurality of layers. For example, processor 330 may execute layers 344 of model 340A.

FIG. 7 illustrates a timeline diagram 700 corresponding to aspects of method 200. FIG. 7 includes a controller 734 (corresponding to a controller and/or firmware of processor 330), instruction manager 736 (corresponding to a controller and/or firmware of processor 330 and more specifically to a direct memory access (DMA) and instruction master), and accelerator agents 738 (corresponding to one or more threads and/or execution units of processor 330).

To start executing a model (e.g., model 340A), controller 734 may send a configuration 746A to instruction manager 736, which may include, for instance, information for loading instructions (e.g., instructions 302 for model 340A). Instruction manager 736 may then fetch instructions for accelerator agents 738 to execute, including an instruction 752A (corresponding to instruction 652A), an instruction 752B (corresponding to instruction 652B), and an instruction 752C (corresponding to instruction 652C).

However, during operation of these instructions, controller 734 may send a request 746B for a higher priority model (e.g., model 340B) to instruction manager 736. Request 746B may remain pending with instruction manager 736 and instruction manager 736 may further recognize instruction 752C as a last instruction of a subgroup (e.g., corresponding to step 202) and in response check for pending requests (e.g., corresponding to step 204). If instruction manager 736 identifies a request (e.g., if request 746B corresponds to a higher priority model), instruction manager 736 may stop fetching instructions for accelerator agents 738. Alternatively, if request 746B is not a higher priority (and/or there is no request 746B), instruction manager 736 may continue fetching instructions (e.g., skipping a context switch) to continue execution while incurring little to no overhead. For example, instruction manager 736 may fetch instruction 752D (which may correspond to a next layer or otherwise a next instruction after instruction 752C) in response to no context switch. As illustrated in FIG. 7, if there is no suitable request 746B to warrant a context switch, instruction manager 736 may continue execution of operations without a significant disruption of the instruction pipeline. In other words, instruction manager 736 may not need to pause, decide, or otherwise wait to confirm whether a context switch will occur. As further illustrated in FIG. 7, the determination of whether to perform the context switch may be completed before instruction 752C completes execution, allowing little to no interruption to the instruction pipeline if no context switch is needed.

Accelerator agents 738 may complete operations of the instructions as fetched by instruction manager 736, reaching an end point (e.g., completing the fetched instructions, as instruction manager 736 previously stopped fetching further instructions in response to request 746B), and send an idle message 762 to instruction manager 736 indicating accelerator agents 738 have completed executing its fetched instructions. Instruction manager 736 may, in response, send an interrupt 764 to initiate a context switch (e.g., corresponding to step 206) based on request 746B, although in other examples may correspond to the highest priority request (e.g., a request preceding request 746B). Controller 734 may send, in response, a read request 766 for identifying the last instruction (e.g., based on an instruction ID and/or a count) to mark the last instruction, which is returned by instruction manager 736 with instruction identifier 768.

Controller 734 may then send configuration 770 for saving a state to instruction manager 736, which may then send a memory spill out instruction 772 to accelerator agents 738. In response, accelerator agents 738 may save the state (e.g., of model 340A after executing layers 342) and respond to instruction manager 736 with a token 774. In response to receiving token 774 which may indicate the save state is complete, instruction manager 736 may send an interrupt 776 to controller 734 to indicate completion of the context save and that accelerator agents 738 are ready for executing the next model. Controller 734 may then send a configuration 778 to instruction manager 736 for loading the requested model (e.g., model 340B). Instruction manager 736 may accordingly fetch instruction 780 for execution by accelerator agents 738 (e.g., corresponding to step 208).

Although not illustrated in FIG. 7, instruction manager 736 may continue fetching instructions (e.g., skipping context switches as described herein) for the second model until reaching a stop point, such as a last instruction corresponding to an end point and having identified a higher priority request, or a last instruction of the model. Instruction manager 736 may then proceed with a context switch as described herein, which may include a restore of a previously saved state. When restoring a state, instruction manager 736 may send an interrupt to controller 734 indicating the state to be restored (e.g., based on instruction identifier 768) and controller 734 may send, in response, an appropriate configuration message to instruction manager 736 to resume execution of the first model (e.g., corresponding to steps 210-212)

As detailed above, context switching may allow a higher priority ML request to start before the existing ML model finishes to support better quality of service (QOS) in an accelerator. The accelerator described herein may run a statically compiled graph. At compile time, multiple points, thus, can be added in the graph by marking them available for context switching events (e.g., min-cut points, memory-based points, as described above). However, as described above, the accelerator may run various workloads such that the accelerator described herein may context switch between different types of inferences without limitation.

In some examples, using hardware and/or firmware, an overhead at a min-cut point may be small (e.g., 1-2% in performance, assuming for example the overhead is ˜1000 cycles given ˜10.0 μs@100 MHz and a min-cut point is added approximately every 500 μs). The systems and methods described herein may further improve performance and efficiency by reducing this overhead (e.g., closer to zero).

Although the controller may incur overhead as described above, the latency overhead of performing a context switch may be direct memory access (DMA) dominated for spilling out activation memory (e.g., the state or context). The maximum overhead of spilling in/out activation memory may in some examples be related to a size of the activation memory data and DMA bandwidth.

Further, the energy penalty of a context switch may involve spilling out and in the activation memory data. If using an example approximated cost of 10 pJ/B and an example approximated size of 1 MB of activation memory data, a maximum total energy per context switch may be (2*1 MB*10 pJ/B)=20 μJ. Assuming spilling out/in happens 20 times per second, the maximum power overhead in this example may be 0.4 mW. Accordingly, as described herein, the systems and methods provided by the present disclosure advantageously improves the functioning of a computer/accelerator by improving performance and efficiency, reducing overhead/latency, and further improving power and thermal performance.

Accelerators may be used to accelerate on-device ML use-cases which often run at a recursive rate such that their inference requests may come at different frames per second and their inference results may be needed before a certain deadline otherwise glitch will be caused. Stacking all the current requests' typical execution latency together may not provide enough time to fulfill all of them. The systems and methods described herein may advantageously provide more flexible and intelligent scheduling mechanisms, as well as a context switching feature for accelerators. With context switching supported on accelerators as described herein, low priority inference tasks may be temporarily suspended so that compute resources may be used for high priority tasks, such that overall QoS may be improved.

### EXAMPLE EMBODIMENTS

Example 1: A computer-implemented method for accelerator context switching may include (i) recognizing, during execution of a first machine learning model, a last instruction of a layer from a subset of a plurality of layers of the first machine learning model; (ii) identifying a request for executing a second machine learning model; and (iii) initiating a context switch to the second machine learning model after executing the last instruction of the layer.
Example 2: The method of Example 1, wherein recognizing the last instruction of the layer comprises reading a last instruction flag in an instruction header of the last instruction.
Example 3: The method of Example 2, wherein the last instruction flag is set by a compiler.
Example 4: The method of Example 2 or 3, wherein the plurality of layers corresponds to a graph, the subset of the plurality of layers corresponds to a subgraph of the graph based on a min-cut point of the graph, and the last instruction flag is set by the compiler for the last instruction of the subset of the plurality of layers.
Example 5: The method of Example 2, 3, or 4, wherein the subset of the plurality of layers is based on a memory usage of the subset of the plurality of layers satisfying a memory usage threshold and the last instruction flag is set by the compiler for the last instruction of the subset of the plurality of layers.
Example 6: The method of any of Examples 1-5, wherein identifying the request for executing the second machine learning model comprises selecting a highest priority request from a plurality of outstanding requests from machine learning models.
Example 7: The method of any of Examples 1-6, further comprising: executing the second machine learning model after the context switch; and performing a second context switch back to the first machine learning model.
Example 8: The method of any of Examples 1-7, further comprising executing a next layer of the plurality of layers when no request having a higher priority than the first machine learning model is identified.
Example 9: The method of any of Examples 1-8, wherein the context switch includes saving a memory state of the subset of the plurality of layers.
Example 10: A system for accelerator context switching may include: at least one physical processor; and physical memory comprising computer-executable instructions that, when executed by the physical processor, cause the physical processor to: recognize, during execution of a first machine learning model, a last instruction of a layer from a subset of a plurality of layers of the first machine learning model; identify a request for executing a second machine learning model; and initiate a context switch to the second machine learning model after executing the last instruction of the layer.
Example 11: The system of Example 10, wherein recognizing the last instruction of the layer comprises reading a last instruction flag set by a compiler in an instruction header of the last instruction.
Example 12: The system of Example 11, wherein the plurality of layers corresponds to a graph, the subset of the plurality of layers corresponds to a subgraph of the graph based on a min-cut point of the graph, and the last instruction flag is set by the compiler for the last instruction of the subset of the plurality of layers.
Example 13: The system of Example 11 or 12, wherein the subset of the plurality of layers is based on a memory usage of the subset of the plurality of layers satisfying a memory usage threshold and the last instruction flag is set by the compiler for the last instruction of the subset of the plurality of layers.
Example 14: The system of any of Examples 10-13, wherein: identifying the request for executing the second machine learning model comprises selecting a highest priority request from a plurality of outstanding requests from machine learning models; and the instructions further comprise instructions for executing a next layer of the plurality of layers when no request having a higher priority than the first machine learning model is identified.
Example 15: The system of any of Examples 10-14, further comprising instructions for: executing the second machine learning model after the context switch; and performing a second context switch back to the first machine learning model.
Example 16: A non-transitory computer-readable medium comprising one or more computer-executable instructions that, when executed by at least one processor of a computing device, cause the computing device to: recognize, during execution of a first machine learning model, a last instruction of a layer from a subset of a plurality of layers of the first machine learning model; identify a request for executing a second machine learning model; and initiate a context switch to the second machine learning model after executing the last instruction of the layer.
Example 17: The non-transitory computer-readable medium of Example 16, wherein recognizing the last instruction of the layer comprises reading a last instruction flag set by a compiler in an instruction header of the last instruction.
Example 18: The non-transitory computer-readable medium of Example 17, wherein the plurality of layers corresponds to a graph, the subset of the plurality of layers corresponds to a subgraph of the graph based on a min-cut point of the graph, and the last instruction flag is set by the compiler for the last instruction of the subset of the plurality of layers.
Example 19: The non-transitory computer-readable medium of Example 17 or 18, wherein the subset of the plurality of layers is based on a memory usage of the subset of the plurality of layers satisfying a memory usage threshold and the last instruction flag is set by the compiler for the last instruction of the subset of the plurality of layers.
Example 20: The non-transitory computer-readable medium of any of Examples 16-19, wherein: identifying the request for executing the second machine learning model comprises selecting a highest priority request from a plurality of outstanding requests from machine learning models; and the instructions further comprise instructions for executing a next layer of the plurality of layers when no request having a higher priority than the first machine learning model is identified.

Embodiments of the present disclosure may include or be implemented in-conjunction with various types of artificial-reality systems. Artificial reality is a form of reality that has been adjusted in some manner before presentation to a user, which may include, for example, a virtual reality, an augmented reality, a mixed reality, a hybrid reality, an extended reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

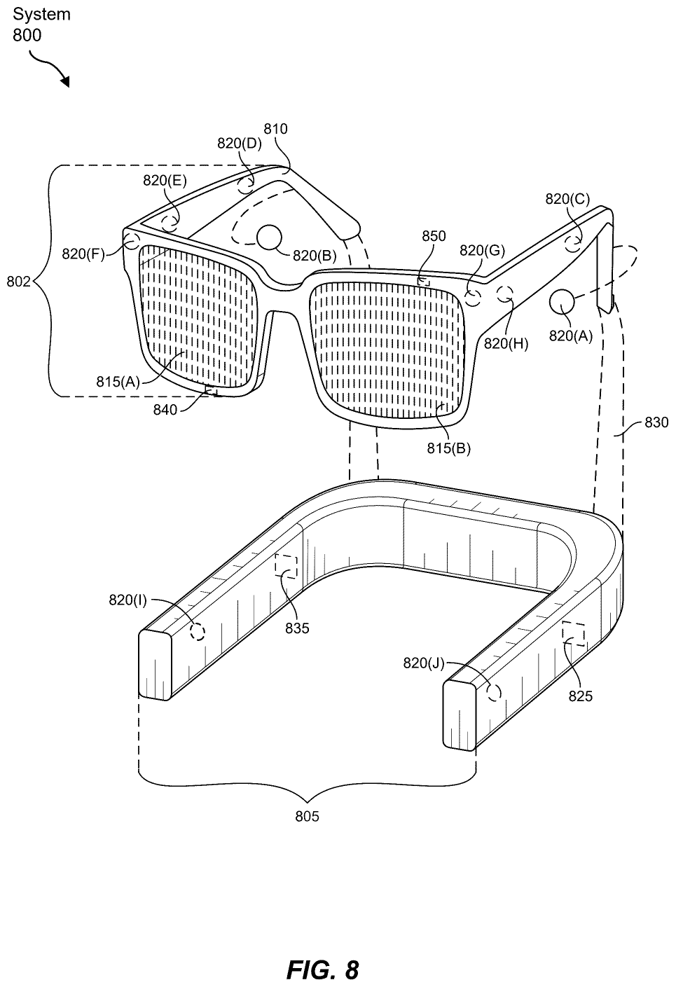

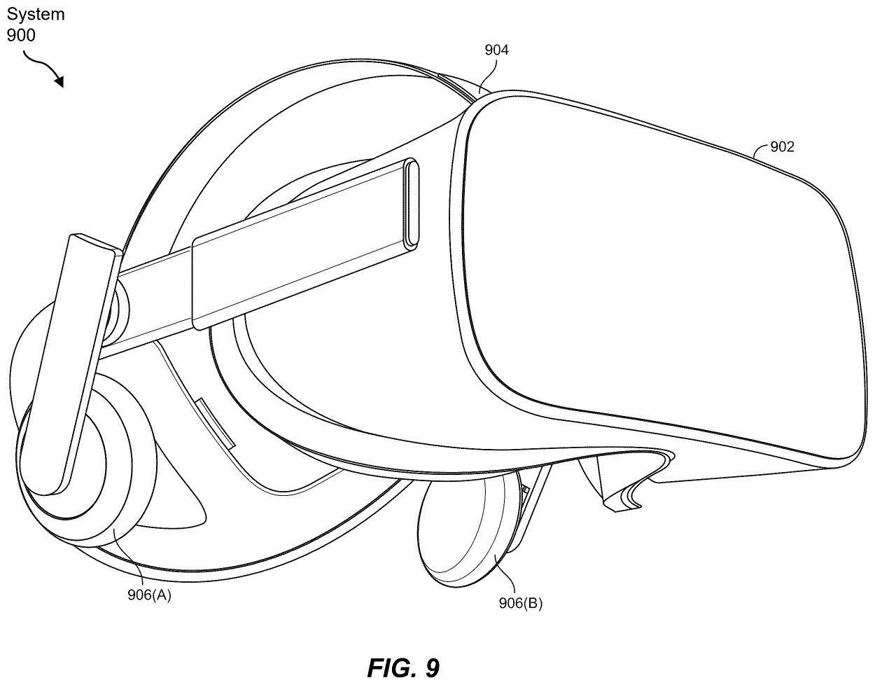

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(I) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality device 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(I) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

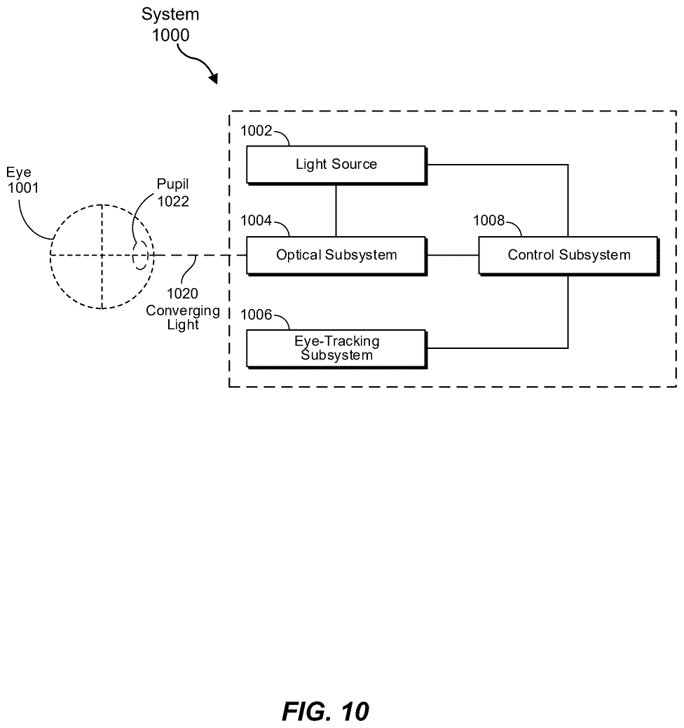

FIG. 10 is an illustration of an exemplary system 1000 that incorporates an eye-tracking subsystem capable of tracking a user's eye(s). As depicted in FIG. 10, system 1000 may include a light source 1002, an optical subsystem 1004, an eye-tracking subsystem 1006, and/or a control subsystem 1008. In some examples, light source 1002 may generate light for an image (e.g., to be presented to an eye 1001 of the viewer). Light source 1002 may represent any of a variety of suitable devices. For example, light source 1002 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1004 may receive the light generated by light source 1002 and generate, based on the received light, converging light 1020 that includes the image. In some examples, optical subsystem 1004 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1020. Further, various mechanical couplings may serve to maintain the relative spacing and/or the orientation of the optical components in any suitable combination.

In one embodiment, eye-tracking subsystem 1006 may generate tracking information indicating a gaze angle of an eye 1001 of the viewer. In this embodiment, control subsystem 1008 may control aspects of optical subsystem 1004 (e.g., the angle of incidence of converging light 1020) based at least in part on this tracking information. Additionally, in some examples, control subsystem 1008 may store and utilize historical tracking information (e.g., a history of the tracking information over a given duration, such as the previous second or fraction thereof) to anticipate the gaze angle of eye 1001 (e.g., an angle between the visual axis and the anatomical axis of eye 1001). In some embodiments, eye-tracking subsystem 1006 may detect radiation emanating from some portion of eye 1001 (e.g., the cornea, the iris, the pupil, or the like) to determine the current gaze angle of eye 1001. In other examples, eye-tracking subsystem 1006 may employ a wavefront sensor to track the current location of the pupil.

Any number of techniques can be used to track eye 1001. Some techniques may involve illuminating eye 1001 with infrared light and measuring reflections with at least one optical sensor that is tuned to be sensitive to the infrared light. Information about how the infrared light is reflected from eye 1001 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1006 may be digitized (i.e., converted to an electronic signal). Further, the sensor may transmit a digital representation of this electronic signal to one or more processors (for example, processors associated with a device including eye-tracking subsystem 1006). Eye-tracking subsystem 1006 may include any of a variety of sensors in a variety of different configurations. For example, eye-tracking subsystem 1006 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1006 to track the movement of eye 1001. In another example, these processors may track the movements of eye 1001 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1006 may be programmed to use an output of the sensor(s) to track movement of eye 1001. In some embodiments, eye-tracking subsystem 1006 may analyze the digital representation generated by the sensors to extract eye rotation information from changes in reflections. In one embodiment, eye-tracking subsystem 1006 may use corneal reflections or glints (also known as Purkinje images) and/or the center of the eye's pupil 1022 as features to track over time.

In some embodiments, eye-tracking subsystem 1006 may use the center of the eye's pupil 1022 and infrared or near-infrared, non-collimated light to create corneal reflections. In these embodiments, eye-tracking subsystem 1006 may use the vector between the center of the eye's pupil 1022 and the corneal reflections to compute the gaze direction of eye 1001. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1006 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1001 may act as a retroreflector as the light reflects off the retina, thereby creating a bright pupil effect similar to a red-eye effect in photography. If the illumination source is offset from the optical path, then the eye's pupil 1022 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1008 may control light source 1002 and/or optical subsystem 1004 to reduce optical aberrations (e.g., chromatic aberrations and/or monochromatic aberrations) of the image that may be caused by or influenced by eye 1001. In some examples, as mentioned above, control subsystem 1008 may use the tracking information from eye-tracking subsystem 1006 to perform such control. For example, in controlling light source 1002, control subsystem 1008 may alter the light generated by light source 1002 (e.g., by way of image rendering) to modify (e.g., pre-distort) the image so that the aberration of the image caused by eye 1001 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

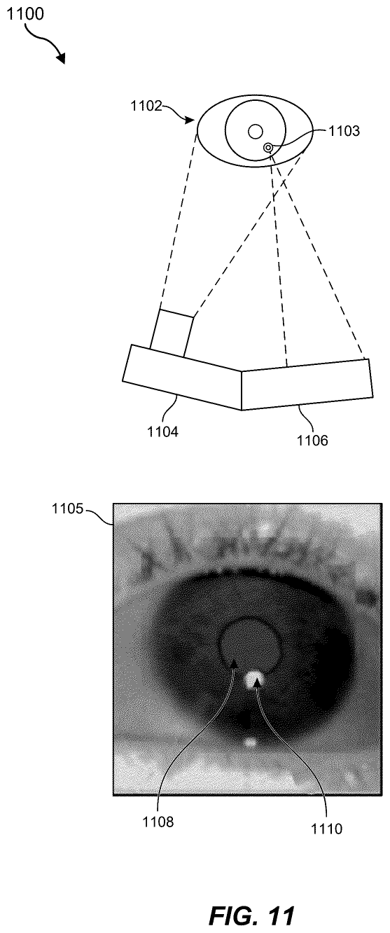

FIG. 11 is a more detailed illustration of various aspects of the eye-tracking subsystem illustrated in FIG. 10. As shown in this figure, an eye-tracking subsystem 1100 may include at least one source 1104 and at least one sensor 1106. Source 1104 generally represents any type or form of element capable of emitting radiation. In one example, source 1104 may generate visible, infrared, and/or near-infrared radiation. In some examples, source 1104 may radiate non-collimated infrared and/or near-infrared portions of the electromagnetic spectrum towards an eye 1102 of a user. Source 1104 may utilize a variety of sampling rates and speeds. For example, the disclosed systems may use sources with higher sampling rates in order to capture fixational eye movements of a user's eye 1102 and/or to correctly measure saccade dynamics of the user's eye 1102. As noted above, any type or form of eye-tracking technique may be used to track the user's eye 1102, including optical-based eye-tracking techniques, ultrasound-based eye-tracking techniques, etc.

Sensor 1106 generally represents any type or form of element capable of detecting radiation, such as radiation reflected off the user's eye 1102. Examples of sensor 1106 include, without limitation, a charge coupled device (CCD), a photodiode array, a complementary metal-oxide-semiconductor (CMOS) based sensor device, and/or the like. In one example, sensor 1106 may represent a sensor having predetermined parameters, including, but not limited to, a dynamic resolution range, linearity, and/or other characteristic selected and/or designed specifically for eye tracking.

As detailed above, eye-tracking subsystem 1100 may generate one or more glints. As detailed above, a glint 1103 may represent reflections of radiation (e.g., infrared radiation from an infrared source, such as source 1104) from the structure of the user's eye. In various embodiments, glint 1103 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 11 shows an example image 1105 captured by an eye-tracking subsystem, such as eye-tracking subsystem 1100. In this example, image 1105 may include both the user's pupil 1108 and a glint 1110 near the same. In some examples, pupil 1108 and/or glint 1110 may be identified using an artificial-intelligence-based algorithm, such as a computer-vision-based algorithm. In one embodiment, image 1105 may represent a single frame in a series of frames that may be analyzed continuously in order to track the eye 1102 of the user. Further, pupil 1108 and/or glint 1110 may be tracked over a period of time to determine a user's gaze.

In one example, eye-tracking subsystem 1100 may be configured to identify and measure the inter-pupillary distance (IPD) of a user. In some embodiments, eye-tracking subsystem 1100 may measure and/or calculate the IPD of the user while the user is wearing the artificial reality system. In these embodiments, eye-tracking subsystem 1100 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1000 and/or eye-tracking subsystem 1100 may be incorporated into augmented-reality system 800 in FIG. 8 and/or virtual-reality system 900 in FIG. 9 to enable these systems to perform various eye-tracking tasks (including one or more of the eye-tracking operations described herein).

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, program, code, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the instructions described herein may transform data, physical devices, and/or representations of physical devices from one form to another. For example, one or more of the instructions recited herein may receive model data to be transformed, transform the model data, output a result of the transformation to provide input to a next layer, use the result of the transformation to perform an inference, and store the result of the transformation to provide the inference. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
recognizing, during execution of a first machine learning model, a last instruction of a layer from a subset of a plurality of layers of the first machine learning model;
identifying a request for executing a second machine learning model; and
performing a context switch to the second machine learning model after executing the last instruction of the layer.

2. The method of claim 1, wherein recognizing the last instruction of the layer comprises reading a last instruction flag in an instruction header of the last instruction.

3. The method of claim 2, wherein the last instruction flag is set by a compiler.

4. The method of claim 3, wherein the plurality of layers corresponds to a graph, the subset of the plurality of layers corresponds to a subgraph of the graph based on a min-cut point of the graph, and the last instruction flag is set by the compiler for the last instruction of the subset of the plurality of layers.

5. The method of claim 3, wherein the subset of the plurality of layers is based on a memory usage of the subset of the plurality of layers satisfying a memory usage threshold and the last instruction flag is set by the compiler for the last instruction of the subset of the plurality of layers.

6. The method of claim 1, wherein identifying the request for executing the second machine learning model comprises selecting a highest priority request from a plurality of outstanding requests from machine learning models.

7. The method of claim 1, further comprising:
executing the second machine learning model after the context switch; and
performing a second context switch back to the first machine learning model.

8. The method of claim 1, further comprising executing a next layer of the plurality of layers when no request having a higher priority than the first machine learning model is identified.

9. The method of claim 1, wherein the context switch includes saving a memory state of the subset of the plurality of layers.

10. A system comprising:
at least one physical processor; and
physical memory comprising computer-executable instructions that, when executed by the physical processor, cause the physical processor to:
recognize, during execution of a first machine learning model, a last instruction of a layer from a subset of a plurality of layers of the first machine learning model;
identify a request for executing a second machine learning model; and
perform a context switch to the second machine learning model after executing the last instruction of the layer.

11. The system of claim 10, wherein recognizing the last instruction of the layer comprises reading a last instruction flag set by a compiler in an instruction header of the last instruction.

12. The system of claim 11, wherein the plurality of layers corresponds to a graph, the subset of the plurality of layers corresponds to a subgraph of the graph based on a min-cut point of the graph, and the last instruction flag is set by the compiler for the last instruction of the subset of the plurality of layers.

13. The system of claim 11, wherein the subset of the plurality of layers is based on a memory usage of the subset of the plurality of layers satisfying a memory usage threshold and the last instruction flag is set by the compiler for the last instruction of the subset of the plurality of layers.

14. The system of claim 10, wherein:
identifying the request for executing the second machine learning model comprises selecting a highest priority request from a plurality of outstanding requests from machine learning models; and
the instructions further comprise instructions for executing a next layer of the plurality of layers when no request having a higher priority than the first machine learning model is identified.

15. The system of claim 10, further comprising instructions for:
executing the second machine learning model after the context switch; and
performing a second context switch back to the first machine learning model.

16. A non-transitory computer-readable medium comprising one or more computer-executable instructions that, when executed by at least one processor of a computing device, cause the computing device to:
recognize, during execution of a first machine learning model, a last instruction of a layer from a subset of a plurality of layers of the first machine learning model;
identify a request for executing a second machine learning model; and
perform a context switch to the second machine learning model after executing the last instruction of the layer.

17. The non-transitory computer-readable medium of claim 16, wherein recognizing the last instruction of the layer comprises reading a last instruction flag set by a compiler in an instruction header of the last instruction.

18. The non-transitory computer-readable medium of claim 17, wherein the plurality of layers corresponds to a graph, the subset of the plurality of layers corresponds to a subgraph of the graph based on a min-cut point of the graph, and the last instruction flag is set by the compiler for the last instruction of the subset of the plurality of layers.

19. The non-transitory computer-readable medium of claim 17, wherein the subset of the plurality of layers is based on a memory usage of the subset of the plurality of layers satisfying a memory usage threshold and the last instruction flag is set by the compiler for the last instruction of the subset of the plurality of layers.

20. The non-transitory computer-readable medium of claim 16, wherein:
identifying the request for executing the second machine learning model comprises selecting a highest priority request from a plurality of outstanding requests from machine learning models; and
the instructions further comprise instructions for executing a next layer of the plurality of layers when no request having a higher priority than the first machine learning model is identified.
